(19) United States
(12) Patent Application Publication
(10) Pub. No.: US 2013/0048192 A1
(43) Pub. Date: Feb. 28, 2013

(54) METHOD FOR SEALING LIGHT ENGINE MODULE WITH FLIP-CHIP LIGHT EMITTING DIODE

(71) Applicant: JESSIE LEE, Taipei City (TW)

(72) Inventor: JESSIE LEE, Taipei City (TW)

(21) Appl. No.: 13/221,906

(22) Filed: Aug. 31, 2011

(51) Int. Cl. H01J 9/227

(52) U.S. Cl. 156/67

(57) ABSTRACT

The sealing method is to firstly form a circuit layout with electrode contacts on a circuit board and flip-chip light emitting diodes (FCLEDs) are electrically connected to the electrode contacts by adhesive material. After the adhesive material is solidified, a plastic ring is attached to the circuit board to surround the LEDs and cycle dispensing is used to coat fluorescent-powder gel within plastic ring on the exposed sides of the LEDs and on the surface of the circuit board between neighboring LEDs. Then, vacuum de-aerating and baking is conducted and a light engine module is formed. In the present invention, the lateral light from the LEDs forms a light extension area where the coated fluorescent-powder gel there is activated and extended planar light is as such produced. The present invention is therefore able to increase lighting efficiency, light projection angle, light brightness, and uniformity.

### (a) TECHNICAL FIELD OF THE INVENTION

The present invention is generally related to light engines using light emitting diodes, and more particular to a light engine module coating fluorescent-powder gel on flip-chip light emitting diodes so as to achieve a planar light source.

### (b) DESCRIPTION OF THE PRIOR ART

Light emitting diodes (LEDs) are energy-efficient, small-form-factored, and highly reliable. White light LEDs have already widely applied to indoor/outdoor lighting and as backlight to LCD panels. How to efficiently achieve uniform planar light with higher brightness from a number of LEDs has been a major issue to the packaging industry. Simply increasing the lighting efficiency of LEDs is not enough to achieve the desired planar light. The packaging industry has been utilizing cup-like reflectors or arranging a large number of LEDs in an array. However, these means often cause problems such as glare, ghost image, inferior heat dissipation, light loss, etc.

### SUMMARY OF THE INVENTION

A major objective of the present invention is to provide a sealing method to a light engine module using flip-chip light emitting diodes (FCLEDs). In the gap between neighboring LEDs, the lateral light from the LEDs forms a light extension area where the coated fluorescent-powder gel there is activated and extended planar light is as such produced. The present invention is therefore able to increase lighting efficiency, light projection angle, light brightness, and uniformity.

The sealing method is to utilize the fluorescent-powder gel's coating to increase the area of light generation and lighting efficiency. Firstly, a circuit layout with electrode contacts is formed on a circuit board and the LEDs are electrically connected to the electrode contacts. Then, a plastic ring is attached to the circuit board to surround the LEDs and cycle dispensing is used to coat fluorescent-powder gel within the area enclosed by the plastic ring on the exposed sides of the LEDs and on the surface of the circuit board between neighboring LEDs.

In order to make complete coverage and to remove air bubbles after dispensing, the present invention conducts vacuum de-aerating in the process before baking so that fluorescent-powder gel is successfully formed on the exposed sides of the LEDs and on the surface of the circuit board between neighboring LEDs. This coating method causes the lateral light from the LEDs to become extended planar light so as to increase lighting efficiency.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top-view diagram showing a light engine module according to an embodiment of the present invention.

FIG. 2 is a side view diagram showing the light engine module of FIG. 1.

FIG. 3 is a top-view diagram showing how the fluorescent-powder gel of the present invention is dispensed.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

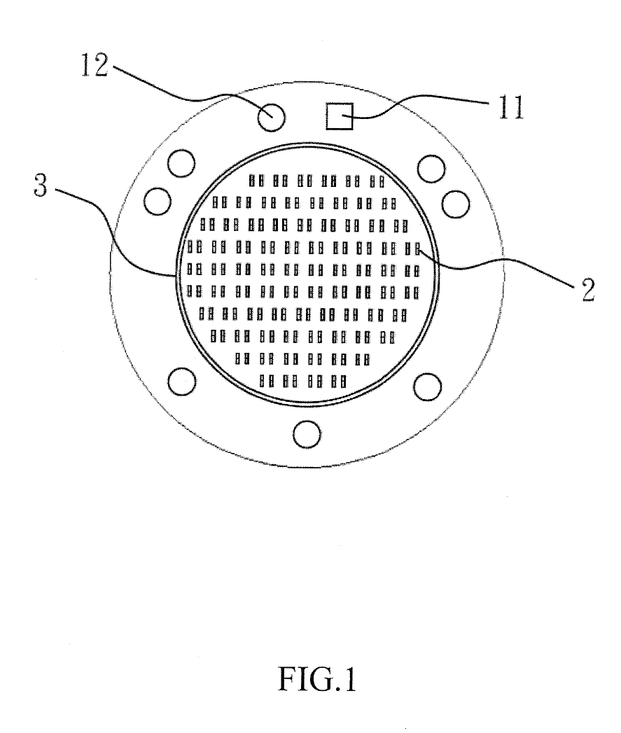

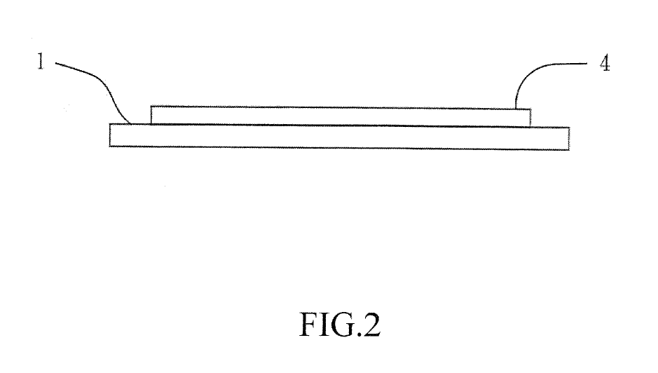

FIGS. 1 and 2 are top-view and side-view diagrams showing a light engine module according to an embodiment of the present invention. As illustrated, the light engine module contains a circuit board 1, light emitting diodes (LEDs) 2, a plastic ring 3, and fluorescent-power gel 4. At least on a first side surface of the circuit board 1, a circuit layout is formed with electrode contacts. The electrode contacts contain at least a pair of positive contact 11 and negative contact 12. In an alternative embodiment, there are circuit layouts on the surfaces of the circuit board's first side and a second side.

Each of the LEDs 2 is a solid, rectangular chip with 6 sides in a flip-chip configuration. Each LED 2 has a P-type electrode and an N-type electrode on a side surface, which are electrically connected to the pairwise electrode contacts on the circuit board 1 under the flip-chip configuration. When a LED 2 is attached to the first aide of the circuit board 1 to establish electrical connections, the LED 2 has 5 sides exposed.

The plastic ring 3 is made of an opaque material and is placed on the first side of the circuit board 1, surrounding the LEDs 2 to define an enclosed area on the first side of the circuit board.

The fluorescent-powder gel 4 is coated within the area defined by the plastic ring 3 to cover each LED 2 and the surface of the circuit board 1 between neighboring LEDs 2. The fluorescent-powder gel 4 is made by uniformly mixing fluorescent powder and a paste at appropriate proportions. The paste could be a transparent or translucent adhesive paste such as epoxy resin or silicone.

There are various ways to coat the fluorescent-powder gel 4 in the area defined by the plastic ring 3. Preferably, the fluorescent-powder gel 4 is coated by circle dispensing.

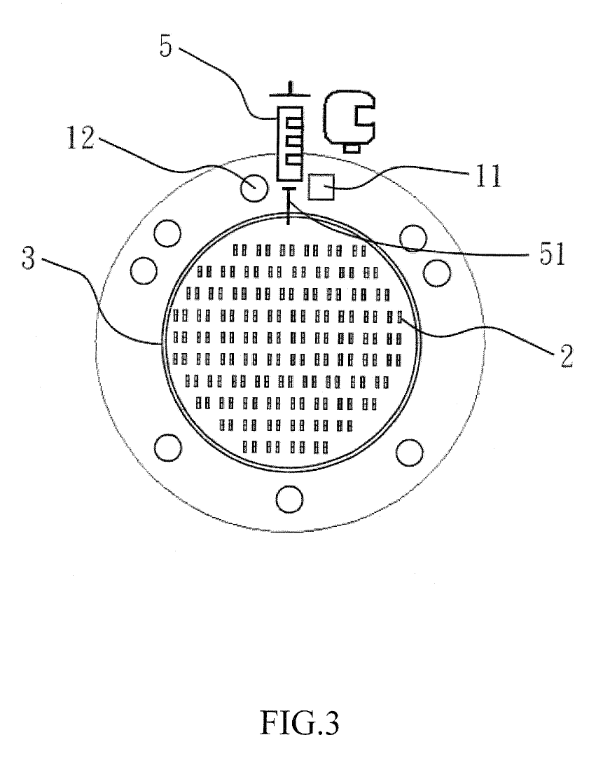

FIG. 3 is a top-view diagram showing how the fluorescent-powder gel 4 is dispensed. As illustrated, to conduct the circle dispensing, a dispensing device 5 is employed and the fluorescent-powder gel 4 is ejected from a nozzle 51 of the dispensing device 5 onto the 5 exposed sides of each LED 2 and the surface of the circuit board 1 between neighboring LEDs 2. The width of the dispensed circle is determined so that so that dome-like gel body is formed. The surface of the gel body then becomes minor-like after contacting with the air. When the LED 2 is turned on, its light radiates radially due to the dome-like gel body. When the first circle is completed and the nozzle 51 is back to the original position, a second round of dispensing is conducted. Since the gel body is formed after the first round, the fluorescent-powder gel 4 in the second round would spread laterally. Then, after a vacuum de-aerating and baking process is conducted, the fluorescent-powder gel 4 is effectively formed on the 5 exposed sides of each LED 2 and the surface of the circuit board 1 between neighboring LEDs 2.

The baking process could be accomplished by a furnace so that the fluorescent-powder gel 4 is quickly melted and uniformly attached to the 5 exposed sides of each LED 2 and the surface of the circuit board 1 between neighboring LEDs 2 within the area defined by the plastic ring 3.

As shown in FIG. 1, as the fluorescent-powder gel 4 is formed on the exposed sides of the LEDs 2, the light emitted laterally from the LEDs 2 activates the fluorescent powder to produce white light. According to Snell's law and as the distance between LEDs 2 is small, light is overlapped among the gaps between the LEDs 2. Since fluorescent-powder gel 4 is also coated in these gaps, the lateral light is extended due to the medium of a same refraction ratio (i.e., the fluorescent-powder gel 4), thereby achieving an extended planar light source, instead of each LED 2 as a point light source. The conventional problem of partial or total reflection suffered by the lateral light of LEDs 2 as it passes through medium of different refraction ratios is as such resolved. The light loss is therefore reduced and the lighting efficiency is enhanced. The circle dispensing described above to achieve a planar light engine module using flip-chip LEDs has at least the following advantages.

Firstly, in the present invention, the circuit board 1 has contacts for electrically connecting the LEDs 2 surrounded by the plastic ring 3 within which the fluorescent-powder gel 4 is coated by circle dispensing on the exposed sides of LEDs 2 and the surface of the circuit board 1 between neighboring LEDs 2. As such, a planar light engine module is achieved as the lateral light from LEDs 2 is overlapped into extended planar light source. The lighting efficiency of the LEDs 2 is therefore enhanced and a uniform planar light is produced.

Secondly, in the present invention, the LEDs 2 are electrically connected to the circuit board 1 directly. Instead of filling epoxy resin after coating fluorescent powder and baking, the light engine module is completed once the fluorescent-powder gel 4 is coated and heated. The heat accumulation of the LEDs 2 by the double-layered epoxy resin is as such reduced, thereby enhancing the operation life of the light engine module. In addition, the light efficiency of the LEDs 2 is not adversely affected subsequently after the epoxy resin becomes yellowish. Furthermore, production complexity and cost could be both reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A sealing method to a light engine module, comprising the steps of:
forming a circuit layout on a first side of a circuit board, said circuit layout having at least a pair of positive and negative electrodes;
attaching a plurality of light emitting diodes (LEDs) on said first side of said circuit board and electrically connecting said LEDs to said electrode contacts, each LED thereby having five exposed sides;
attaching a plastic on said first side of said circuit board, thereby defining an area encircling said LEDs; and
coating fluorescent-powder gal within said area on said exposed sides of said LEDs and the surface on said first side between neighboring LEDs;
wherein lateral light from said LEDs is overlapped and an extended planar light source is formed, thereby increasing lighting efficiency of said LEDs.

2. The sealing method according to claim 1, wherein said fluorescent-powder gel is coated by a dispensing device with a nozzle and said fluorescent-powder gel is ejected out of said nozzle.

3. The sealing method according to claim 1, wherein said circuit layout is also formed on a second side of said circuit layout.

4. The sealing method according to claim 1, wherein each of said LED is a solid, rectangular chip with six sides in a flip-chip configuration.

5. The sealing method according to claim 1, wherein said fluorescent-powder gel is made by uniformly mixing fluorescent powder and a paste at appropriate proportions.

6. The sealing method according to claim 5, wherein said paste is a transparent or translucent adhesive paste, and is one of epoxy resin and silicone.
